(19) United States
(12) Patent Application Publication
(10) Pub. No.: US 2026/0132863 A1
(43) Pub. Date: May 14, 2026

(54) WATERPROOF VALVE FOR CONNECTING ENAMELED WIRES AND TERMINAL PINS

(71) Applicant: Xiamen Koge Micro Tech Co., Ltd., Xiamen (CN)

(72) Inventors: Congnan GAO, Xiamen (CN); Qiugui ZHENG, Xiamen (CN)

(21) Appl. No.: 19/260,966

(22) Filed: Jul. 7, 2025

(30) Foreign Application Priority Data
Nov. 14, 2024 (CN) 202411625481.5

(51) Int. Cl. F16K 31/06

(52) U.S. Cl. CPC F16K 31/06

(57) ABSTRACT

A waterproof valve for connecting enameled wires and terminal pins includes a valve body and terminal pins on the valve body, where a side wall of the valve body is configured with mounting grooves, each of the terminal pins is folded in half to form a folded portion, the folded portion is inserted into fixed by glue bonding in a respective one of the mounting grooves, the mounting grooves are open to the side wall of the valve body, a first end and a second end of each of the terminal pins protrude from an upper end of a respective one of the mounting grooves, the first end extends vertically to form a vertical portion, the second end is bent in a direction away from the vertical portion to form a bent portion, and the enameled wires are positioned on and welded to the bent portion.

### CROSS-REFERENCE TO RELATED APPLICATION

This application claims the priority benefit of China application No. 202411625481.5, filed on November 14, 2024. The entirety of China application No. 202411625481.5 is hereby incorporated by reference herein and made a part of this specification.

### TECHNICAL FIELD

The present application relates to the technical field of fluid valves, in particular, to a waterproof valve for connecting enameled wires and terminal pins.

### DESCRIPTION OF RELATED ART

A waterproof valve, also known as a one-way valve, check valve, or non-return valve, is a common valve, whose core function is to ensure that fluid (gas or liquid) flows in only one direction. Because of this feature, the waterproof valve plays a crucial role in hydraulic systems, effectively protecting high-value components from the influence of pressure shocks and flow shocks.

The waterproof valve mainly includes an electromagnetic coil, a valve core, a spring, a valve seat, a valve body, and other components. The opening and closing of the valve are controlled by energizing and de-energizing the electromagnetic coil. When the electromagnetic coil is energized, an electromagnetic force is generated to drive the valve core to move. When the electromagnetic coil is de-energized, the electromagnetic force disappears, and the valve core returns to its original position through the spring or other reset mechanisms, thereby achieving the purpose of closing or opening the valve.

Two terminal pins are mounted on the outer side of the housing of the waterproof valve. Enameled wires penetrate the housing and are connected to these two terminal pins respectively. An end of each terminal pin is connected to an external lead wire, allowing electrical signals to be transmitted through the terminal pins, to control the energization or de-energization of the electromagnetic coil. The enameled wire is so connected to the terminal pin that the enameled wire is manually wound around the terminal pin for multiple turns and then is dipped in tin, which is a complicated and inefficient process.

### SUMMARY

To facilitate the connection of enameled wires, the present application provides a waterproof valve for connecting enameled wires and terminal pins.

A waterproof valve for connecting enameled wires and terminal pins includes a valve body and terminal pins on the valve body, where a side wall of the valve body is configured with mounting grooves, each of the terminal pins is folded in half to form a folded portion, the folded portion is inserted into fixed by glue bonding in a respective one of the mounting grooves, the mounting grooves are open to the side wall of the valve body, a first end and a second end of each of the terminal pins protrude from an upper end of a respective one of the mounting grooves, the first end extends vertically to form a vertical portion, the second end is bent in a direction away from the vertical portion to form a bent portion, and the enameled wires are positioned on and welded to the bent portion.

By adopting the above technical solution, the structure of the terminal pins is modified to allow direct welding of the enameled wires to the bent portion, thereby improving the connection efficiency between the enameled wires and the terminal pins. The vertical portions are designed to be connected with external lead wires. In this solution, due to the modification in the structure of the terminal pins, the installation thereof and of the valve body is adjusted synchronously. The terminal pins are folded in half and inserted into and then fixed by glue bonding in the mounting grooves. The mounting grooves are open to the surface of valve body, facilitating glue injection and installation.

Optionally, a plurality of extension blocks are provided on an inner side wall of each of the mounting grooves, and a clearance is formed between every two adjacent ones of the plurality of extension blocks to form a glue injection space.

By adopting the above technical solution, glue injection spaces are formed between the extension blocks. After the glue is injected, under the action of capillary forces, the glue can more easily migrate into the inner wall of the mounting grooves to fix the terminal pins.

Optionally, a hole is formed on a side wall of each of the terminal pins corresponding to the glue injection space.

By adopting the above technical solution, holes are formed in the side walls of the terminal pins, allowing the glue to enter into the holes and further migrate into the inner cavity of the bent portion of the terminal pins, so as to fill the gaps within the inner cavity of the bent portion, thereby additionally fixing the terminal pins. Additionally, an insulating layer can be formed on the folded inner wall, enhancing the stability of the terminal pins.

Optionally, free spaces are formed in the side wall of the valve body, the enameled wires extend within the free spaces, each of the free spaces is in communication with a respective one of the mounting grooves, and both the vertical portion and the bent portion are accommodated within a respective one of the free spaces.

By adopting the above technical solution, the terminal pins and enameled wires are positioned within the free spaces, making the overall structure more compact and reasonable.

Optionally, an enlarged groove is formed at a bottom end of each of the mounting grooves away from the respective one of the free spaces, the enlarged groove is circular, and a diameter of the enlarged groove is greater than a width of the respective one of the mounting grooves.

When the terminal pins are folded, bulging portions tend to form at their ends. By adopting the above technical solution, these bulging portions can be engaged with the enlarged grooves, thereby enhancing the pull-out resistance of the terminal pins.

Optionally, an extension column is vertically fixed on an inner bottom of each of the free spaces, a gap is formed between the extension column and the vertical portion, and the enameled wires pass through the gap and is always positioned on an upper surface of the bent portion.

By adopting the above technical solution, the enameled wires can be positioned on the upper surface of the bent portion by the extension column, thereby facilitating welding without the requirements for adjusting the position of the enameled wires before welding.

Optionally, a groove is formed in the inner bottom of each of the free spaces, and when each of the terminal pins is installed in a respective one of the mounting grooves, the bent portion abuts against an inner wall of the groove and the upper surface of the bent portion is flush with the inner bottom of the respective one of the free spaces.

By adopting the above technical solution, the stability of the bent portion is improved, and it is convenient to weld the enameled wires and the bent portion.

Optionally, the bent portion is folded in half to form a protrusion extending downwards and a slit on the upper surface of the bent portion, the enameled wires cross the slit, and a locating slot is formed in a bottom surface of the groove for clamping the protrusion extending downwards.

By adopting the above technical solution, the protrusion can be inserted into the locating slot, thereby further enhancing the stability of the bent portion after it is installed in the groove.

Optionally, the valve body includes a valve head with a flow channel and a valve seat, a first cavity is formed on a side of the valve head facing the valve seat and communicates with the flow channel, an elastic valve plate is provided within the first cavity, a control assembly is provided within the valve seat, and the control assembly is connected with the enameled wires and is configured to drive the valve plate to close the flow channel or to move the valve plate away from the flow channel.

Optionally, a second cavity is formed in the valve seat and extends to a side of the valve seat facing the valve head, the control assembly includes a magnetic ring in the second cavity, a connecting rod slidably passing through the magnetic ring, and an iron sheet on a side wall of the connecting rod, a coil is arranged in the magnetic ring and configured to be connected with the enameled wires, an end of the connecting rod away from the iron sheet is connected to the valve plate, an elastic member is provided between the magnetic ring and the connecting rod, and when the magnetic ring is energized to generate a magnetic force, the iron sheet is driven to move toward the magnetic ring, thereby moving the connecting rod, so as to move the valve plate to close the flow channel, and the elastic member provides a force urging the connecting rod to move away from the valve plate.

In conclusion, the present application includes at least one of the following beneficial technical effects:

1. By modifying the structure of the terminal pins, the enameled wires can be directly welded to the bent portion, thereby improving the connection efficiency between the enameled wires and the terminal pins, and further improving work efficiency.

2. The terminal pins are inserted into and fixed by glue bonding in the mounting grooves. Through the clearances between the extension blocks, the glue can more easily migrate into the gaps between the mounting grooves and the terminal pins, thereby improving the fixing effect on the terminal pins.

### BRIEF DESCRIPTION OF THE DRAWINGS

FIG. 1 is a structural view of an embodiment of the present application;

FIG. 2 is an exploded view illustrating the terminal pins in an embodiment of the present application;

FIG. 3 is a partial view illustrating the mounting groove in an embodiment of the present application;

FIG. 4 is a schematic view of the terminal pin in an embodiment of the present application;

FIG. 5 is a cross-sectional view of the present application.

### DESCRIPTION OF THE EMBODIMENTS

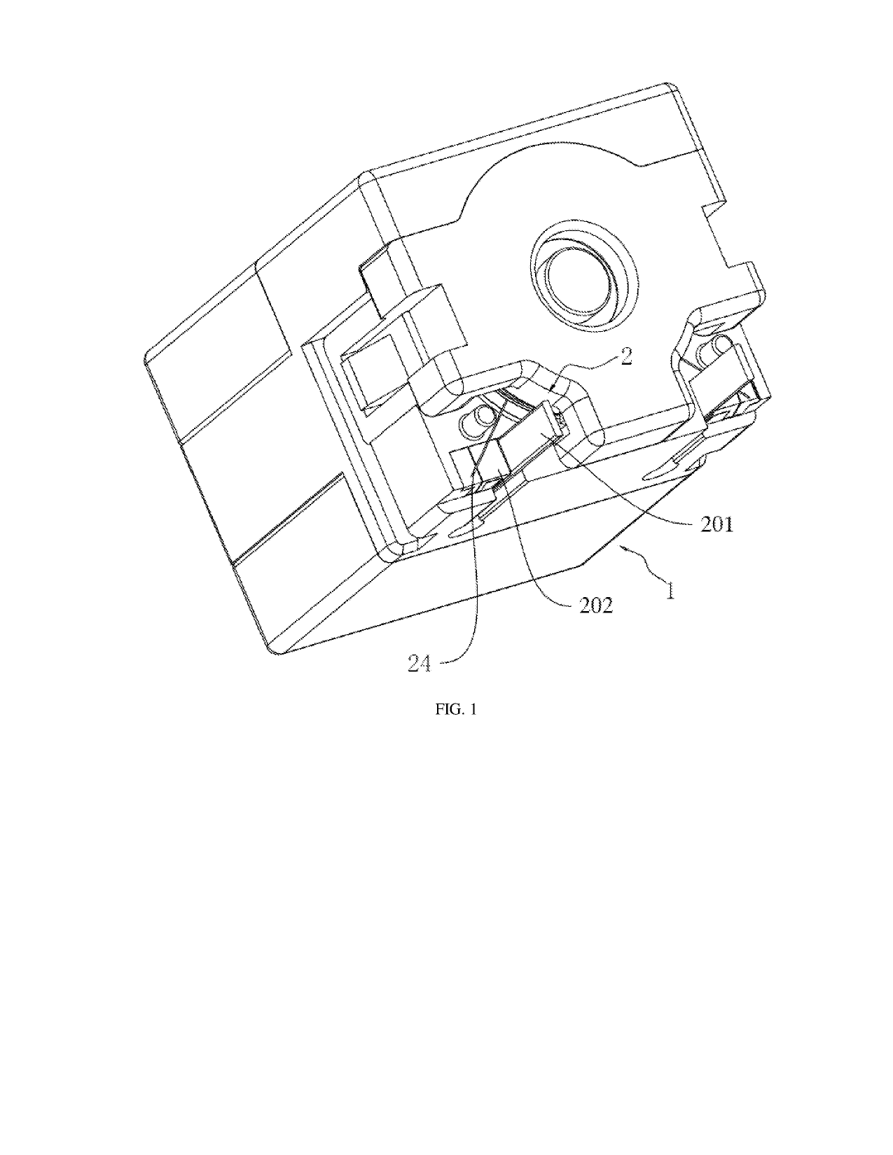

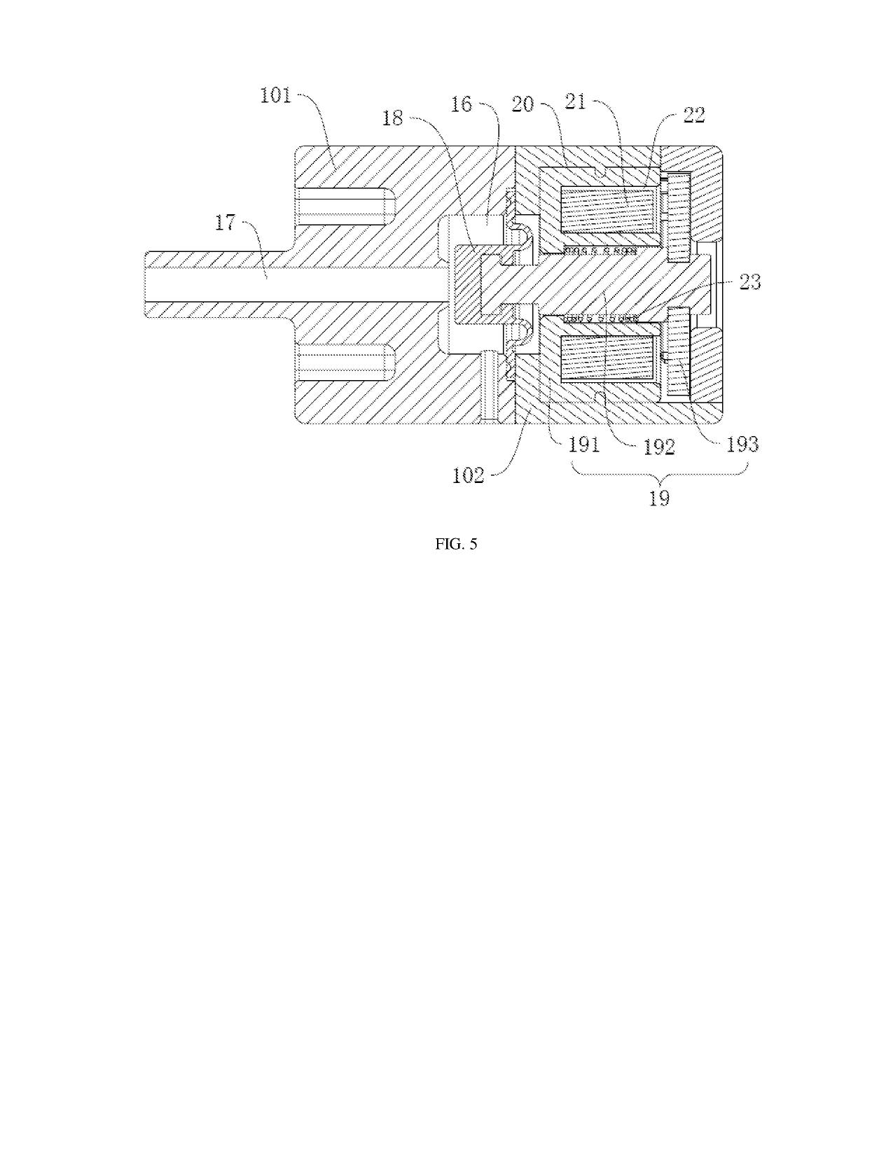

The present application is further described in detail in combination with FIGS. 1-5.

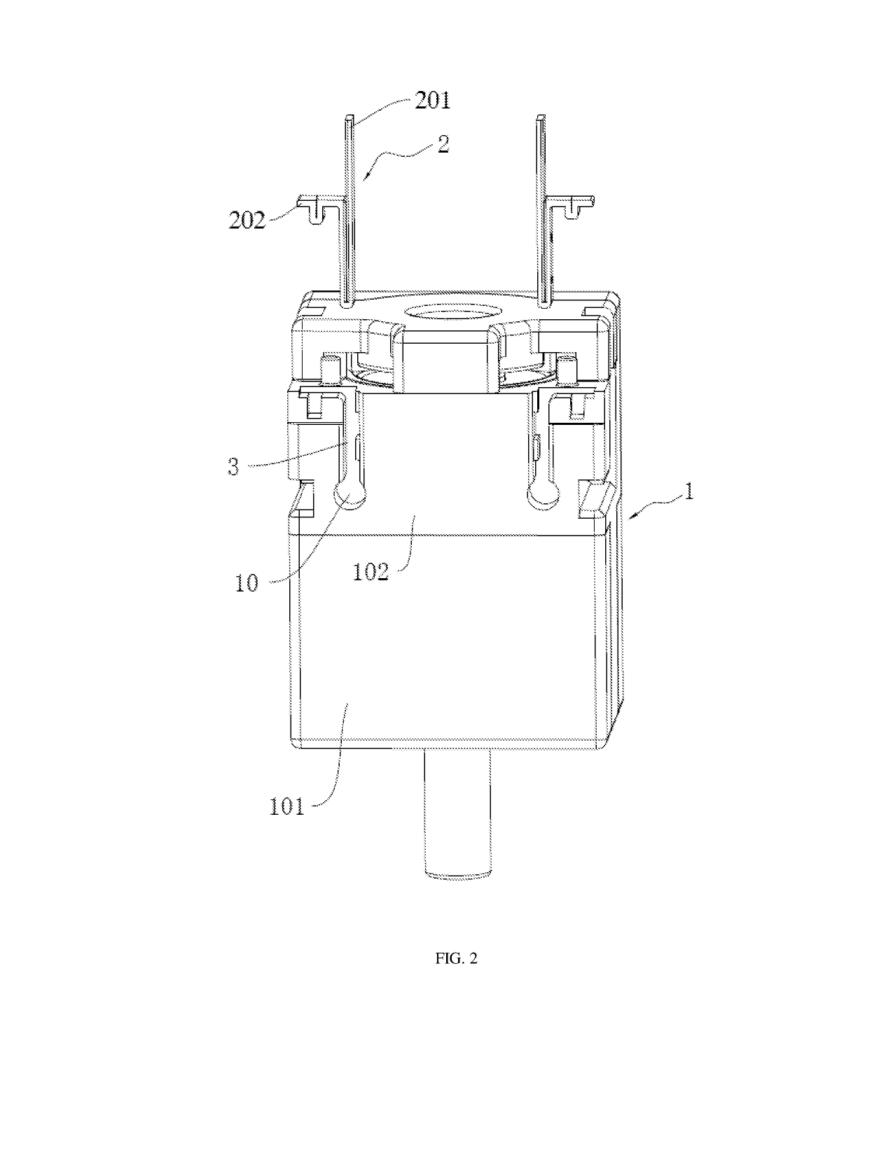

The present application discloses a waterproof valve for connecting enameled wires and terminal pins. Referring to FIGS. 1-2, the waterproof valve includes a valve body 1 and two terminal pins 2 mounted on the surface of the valve body 1. The two terminal pins 2 are located at adjacent corners of the valve body 1 respectively. The two terminal pins 2 are respectively connected with a positive pole and a negative pole of an enameled wire 24.

Each terminal pin 2 is formed by folding a long plate-shaped structure in half. A side wall of the valve body 1 is configured with two mounting grooves 3, and the folded portion of each terminal pin 2 is inserted into the respective mounting groove 3. The upper end of each mounting groove 3 is open towards the upper surface of the valve body 1. After each terminal pin 2 is inserted into the mounting groove 3, two ends of each terminal pin 2 extend beyond the upper end of the mounting groove 3, where one end thereof extends vertically upward to form a vertical portion 201, and the other end thereof is bent 90° away from the vertical portion 201 to form a bent portion 202. Additionally, the mounting grooves 3 are open toward the side wall of the valve body 1 to facilitate glue injection. The vertical portions 201 are used to be connected with external lead wires, and the bent portions 202 are used to be welded with the enameled wires 24. Each enameled wire 24 is positioned on the upper surface of the bent portion 202 after it protrudes from the surface of the valve body 1.

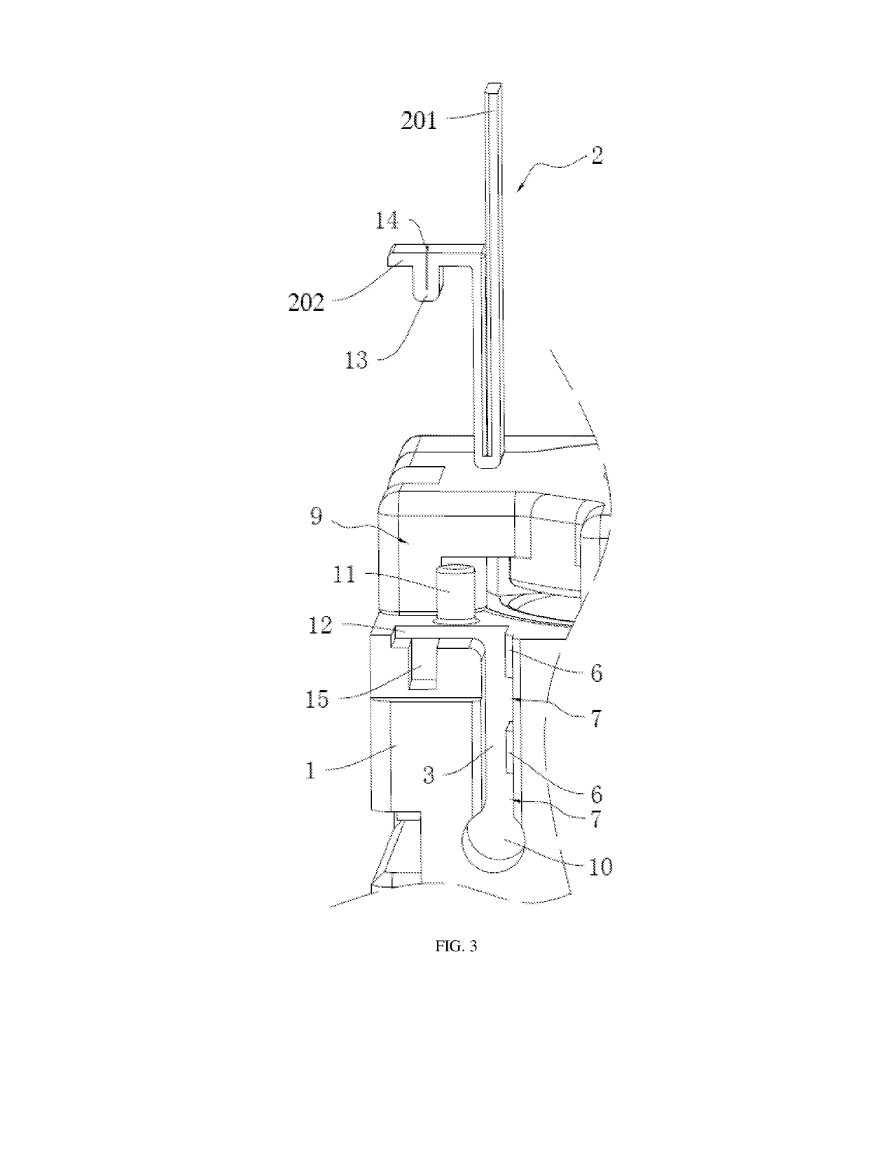

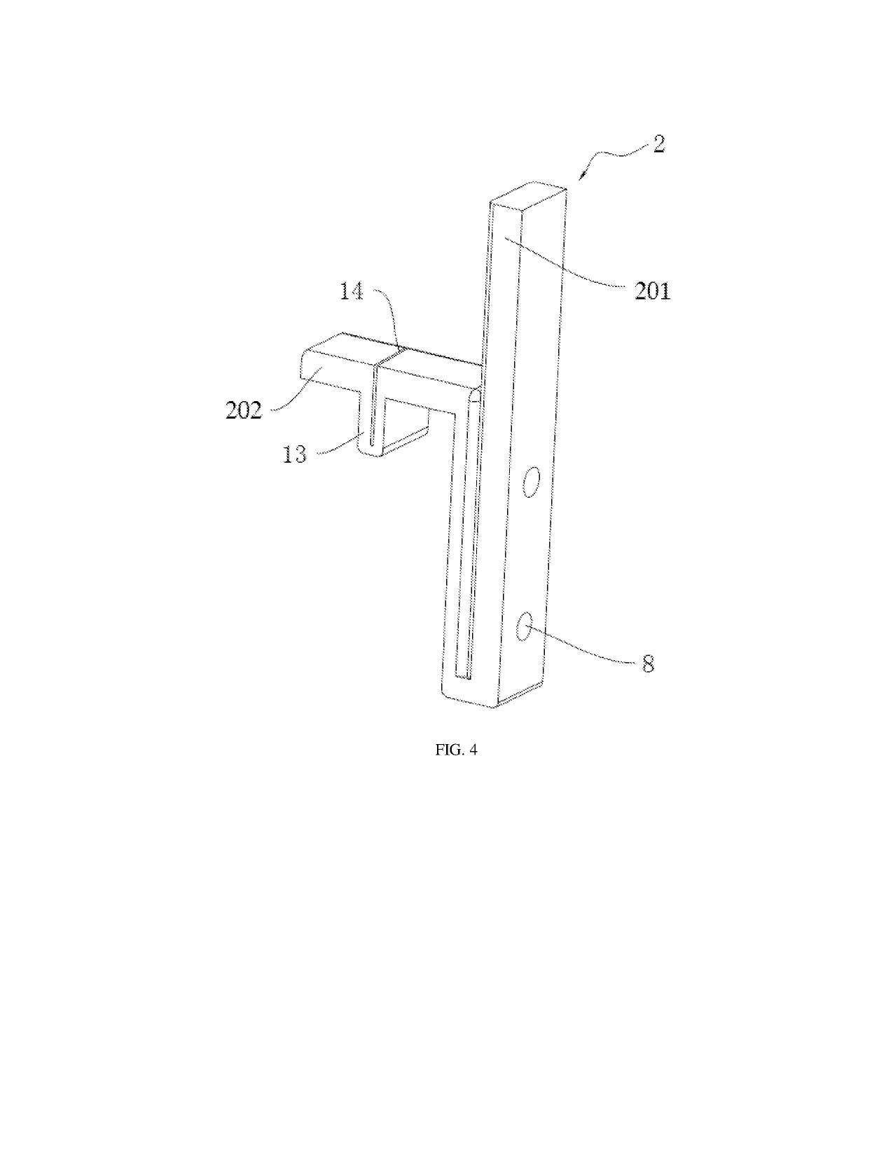

Referring to FIGS. 2-3, a plurality of extension blocks 6 are fixed on the side face of each mounting groove 3 away from the bent portion 202. A certain clearance exists between the respective adjacent extension blocks 6, to form a glue injection space. The surfaces of the extension blocks 6 are configured with a rough texture to enhance the bonding with the glue. In this embodiment, two extension blocks 6 are provided within each mounting groove 3, by which one extension block 6 is located at the upper end of the mounting groove 3 while the other extension block 6 is near the middle of the mounting groove 3 in vertical direction. Two glue injection spaces 7 are formed by the two extension blocks 6. After the glue enters the glue injection spaces 7, it is easier for the glue to migrate into the slit between mounting groove 3 and terminal pin 2. Further, in combination with FIG. 4, a hole 8 is formed on a side of each terminal pin 2 close to the glue injection space 7. The hole 8 penetrates two sides of the terminal pin 2 and is in communication with the internal cavity of the bent portion 202. The glue can enter the hole 8 and flow into the cavity between the bent portion 202 and the vertical portion 201 of terminal pin 2, thereby further enhancing the fixing effect on the terminal pin 2.

Further, referring to FIGS. 2-3, the side wall of the valve body 1 is configured with two free spaces 9. The upper end of the mounting groove 3 communicates with the respective free space 9. The enameled wire 24, the bent portion 202, and the vertical portion 201 are all accommodated within the free space 9, so as to realize a more compact and reasonable structural layout of the valve body 1 as a whole. Additionally, a vertical extension column 11 is fixed within each free space 9, with a slit between extension column 11 and the vertical portion 201. The enameled wire 24 extends between the extension column 11 and the vertical portion 201, and can always remain on the surface of the bent portion 202 under the limiting function of both, which facilitates direct welding.

Furthermore, an enlarged groove 10 is formed at an end of each mounting groove 3 away from the free space 9. The enlarged groove 10 is circular, and the diameter of the enlarged groove 10 is greater than the width of the mounting groove 3. When each terminal pin 2 is folded in half, a bulging portion tends to form at its fold, and the enlarged groove 10 provides an accommodation space for the bulging portion. Additionally, once the terminal pins 2 are connected, the enlarged grooves 10 can enhance the pull-out resistance of the terminal pins 2.

In a further embodiment, a groove 12 corresponding to the bent portion 202 is formed on a bottom surface of each free space 9. When the terminal pin 2 is installed in the mounting groove 3, the bent portion 202 abuts against the groove 12, and the upper surface of the bent portion 202 is flush with the inner bottom surface of the free space 9. The inner wall of the groove 12 may also be coated with glue to stably fix the bent portion 202 within the groove 12. Additionally, the bent portion 202 is folded in half to form a downward-extending protrusion 13 and a slit 14 on its surface. When the enameled wire 24 crosses the slit 14 and is welded to the bent portion 202, the liquid metal in the molten pool can migrate into the slit 14 and form a firm metallurgical bond with the base material, thereby enhancing the connection stability between the enameled wire 24 and the bent portion 202. In addition, a locating slot 15 is formed on the bottom surface of the groove 12. The protrusion 13 can be clamped in the locating slot 15, where it is interference-seated in the locating slot 15.

In a further embodiment, the valve body 1 includes a valve head 101 and a valve seat 102, which are detachably connected with each other through a snap-fit connection, etc.. A side of the valve head 101 facing the valve seat 102 is configured with a first cavity 16, and the valve head 101 is configured with a flow channel 17 in communication with the first cavity 16. External liquid is injected into the first cavity 16 through pipes or other means, and then discharged through the flow channel 17. A valve plate 18 is mounted within the first cavity 16, and a control assembly 19 is installed in the valve body 1. The control assembly 19 is connected with the enameled wires 24 to control the valve plate 18 to close the opening of the flow channel 17 at an end close to the first cavity 16 or to leave the flow channel 17. When the valve plate 18 closes the opening of the flow channel 17, the valve body 1 is in a closed state. When the valve plate 18 leaves the flow channel 17, the valve body 1 is in an open state. The valve plate 18 is made of materials such as elastic alloy steel, featuring durability and stable deformation. An edge of the valve plate 18 is inserted into the valve head 101, and when the valve head 101 and the valve seat 102 are connected together, the valve plate 18 is clamped between the valve head 101 and the valve seat 102, so that the edge of the valve plate 18 is stably connected to the valve head 101.

The valve seat 102 is configured with a second cavity 20 that extends through to a side of the valve seat 102 facing the valve head 101. An end of the second cavity 20 close to the valve head 101 is reduced. The control assembly 19 includes a magnetic ring 191 mounted within the second cavity 20, a connecting rod 192 slidably passing through the magnetic ring 191, and an iron sheet 193 mounted on the outer wall of the connecting rod 192. The magnetic ring 191 is configured to be ringlike, and an outer wall of the magnetic ring 191 is inserted into an inner wall of the second cavity 20 by ribbed rings or the like, preventing the magnetic ring 191 from sliding within the second cavity 20. An annular groove 22 is formed in the magnetic ring 191, and a coil 21 is mounted in the annular groove 22. The coil 21 is connected to the enameled wires 24 to energize the coil 21 through an external power source.

The iron sheet 193 is mounted on an outer wall at an end of the connecting rod 192 away from the valve head 101. The iron sheet 193 and the connecting rod 192 are connected with each other through a snap-fit connection or the like, so that the connecting rod 192 can move the iron sheet 193 synchronously when sliding. An end of the connecting rod 192 away from the iron sheet 193 is engaged with the valve plate 18, which allows for convenient installation and a simple structure. Therefore, the connecting rod 192 can drive both the iron sheet 193 and the valve plate 18 to move synchronously when sliding.

An elastic member 23, specifically a spring, is further provided between the inner wall of the magnetic ring 191 and the connecting rod 192. One end of the elastic member 23 is connected to the inner wall of the magnetic ring 191 while the other end thereof is connected to the outer wall of the connecting rod 192. To facilitate the spring’s elastic force, steps are formed at corresponding positions on the magnetic ring 191 and the connecting rod 192. Under the action of the elastic member 23, a certain distance is maintained between the iron sheet 193 and the magnetic ring 191, and the valve plate 18 is separated from the flow channel 17. When the coil 21 is energized, the magnetic ring 191 becomes magnetized and attracts the iron sheet 193 to move toward the magnetic ring 191 and the iron sheet 193 is adhered magnetically to the magnetic ring 191. The iron sheet 193 synchronously drives the connecting rod 192 to move, so that the connecting rod 192 pushes the valve plate 18 against the flow channel 17. At this moment, the elastic member 23 is compressed. When the coil 21 is de-energized, the elastic member 23 drives the connecting rod 192 back to its original position, so as to separate the valve plate 18 from the flow channel 17.

The implementing principle of the waterproof valve for connecting enameled wires and terminal pins of the present application is as follows. By modifying the structure of the terminal pins 2, the enameled wires 24 can be connected to the terminal pins 2 through welding. In this embodiment, the terminal pins 2 are fixed in the mounting grooves 3 through glue bonding, which enables convenient installation and provides a reliable connection effect.

The above are all exemplary embodiments of the present application and are not intended to limit the protection scope of the present application. Therefore, any equivalent modifications made according to the structure, shape, and principle of the present application shall be included within the protection scope of the present application.

### LIST OF REFERENCE SIGNS

1 valve body

101 valve head

102 valve seat

2 terminal pin

201 vertical portion

202 bent portion

3 mounting groove

6 extension block

7 glue injection space

8 hole

9 free space

10 enlarged groove

11 extension column

12 groove

13 protrusion

14 slit

15 locating slot

16 first cavity

17 flow channel

18 valve plate

19 control assembly

191 magnetic ring

192 connecting rod

193 iron sheet

20 second cavity

21 coil

22 annular groove

23 elastic member

24 enameled wire

What is claimed is:

1. A waterproof valve for connecting enameled wires and terminal pins, comprising a valve body and the terminal pins on the valve body, wherein a side wall of the valve body is configured with mounting grooves, each of the terminal pins is folded in half to form a folded portion, the folded portion is inserted into a respective one of the mounting grooves and fixed by glue bonding, the mounting grooves are open to the side wall of the valve body, a first end and a second end of each of the terminal pins protrude from an upper end of a respective one of the mounting grooves, the first end extends vertically to form a vertical portion, the second end is bent in a direction away from the vertical portion to form a bent portion, and the enameled wires are positioned on and welded to the bent portion.

2. The waterproof valve for connecting enameled wires and terminal pins according to claim 1, wherein a plurality of extension blocks are provided on an inner sidewall of each of the mounting grooves, and a clearance is formed between every two adjacent ones of the plurality of extension blocks to form a glue injection space.

3. The waterproof valve for connecting enameled wires and terminal pins according to claim 2, wherein a hole is formed on a side wall of each of the terminal pins corresponding to the glue injection space.

4. The waterproof valve for connecting enameled wires and terminal pins according to claim 2, wherein free spaces are formed in the side wall of the valve body, the enameled wires extend within the free spaces, each of the free spaces is in communication with a respective one of the mounting grooves, and both the vertical portion and the bent portion are accommodated within a respective one of the free spaces.

5. The waterproof valve for connecting enameled wires and terminal pins according to claim 4, wherein an enlarged groove is formed at a bottom end of each of the mounting grooves away from the respective one of the free spaces, the enlarged groove is circular, and a diameter of the enlarged groove is greater than a width of the respective one of the mounting grooves.

6. The waterproof valve for connecting enameled wires and terminal pins according to claim 4, wherein an extension column is vertically fixed on an inner bottom of each of the free spaces, a gap is formed between the extension column and the vertical portion, and the enameled wires pass through the gap and are always positioned on an upper surface of the bent portion.

7. The waterproof valve for connecting enameled wires and terminal pins according to claim 6, wherein a groove is formed in the inner bottom of each of the free spaces, and when each of the terminal pins is installed in a respective one of the mounting grooves, the bent portion abuts against an inner wall of the groove and the upper surface of the bent portion is flush with the inner bottom of the respective one of the free spaces.

8. The waterproof valve for connecting enameled wires and terminal pins according to claim 7, wherein the bent portion is folded in half to form a protrusion extending downwards and a slit on the upper surface of the bent portion, the enameled wires cross the slit, and a locating slot is formed in a bottom surface of the groove for clamping the protrusion extending downwards.

9. The waterproof valve for connecting enameled wires and terminal pins according to claim 1, wherein the valve body comprises a valve head with a flow channel and a valve seat, a first cavity is formed on a side of the valve head facing the valve seat and communicates with the flow channel, an elastic valve plate is provided within the first cavity, a control assembly is provided within the valve seat, and the control assembly is connected with the enameled wires and is configured to drive the elastic valve plate to close the flow channel or to move the elastic valve plate away from the flow channel.

10. The waterproof valve for connecting enameled wires and terminal pins according to claim 9, wherein a second cavity is formed in the valve seat and extends to a side of the valve seat facing the valve head, the control assembly comprises a magnetic ring in the second cavity, a connecting rod slidably passing through the magnetic ring, and an iron sheet on a side wall of the connecting rod, a coil is arranged in the magnetic ring and configured to be connected with the enameled wires, an end of the connecting rod away from the iron sheet is connected to the elastic valve plate, an elastic member is provided between the magnetic ring and the connecting rod, and when the magnetic ring is energized to generate a magnetic force, the iron sheet is driven to move toward the magnetic ring, thereby moving the connecting rod, so as to move the elastic valve plate to close the flow channel, and the elastic member provides a force urging the connecting rod to move away from the elastic valve plate.
